(19) United States
(12) Patent Application Publication
(10) Pub. No.: US 2003/0217353 A1
(43) Pub. Date: Nov. 20, 2003

(54) Method and system for an adaptable user interface in a debugger

(76) Inventors: Don W. Bebout, Fountain Valley, CA (US); Varsha T. Shamabhat, Rancho Santa Margarita, CA (US)

Correspondence Address: FARJAMI & FARJAMI LLP, 16148 SAND CANYON, IRVINE, CA, 92618, US

(21) Appl. No.: 10/147,379

(22) Filed: May 15, 2002

(51) Int. Cl. G06F 9/44; G06F 9/00

(52) U.S. Cl. 717/125; 709/328

(57) ABSTRACT

One disclosed embodiment is a method for adapting a user interface of a debugger to a given target where the method includes querying the target for target-specific information. For example, the target is queried by a debug core in the debugger to obtain target-specific information such as register groups, a register map, information about compound registers, memory address spaces, and memory blocks in the particular target being debugged. In this embodiment, the debugger interfaces with the target through various register and memory APIs. After the target-specific information is obtained by the debug core in the debugger, such information is transmitted to the user interface in the debugger. Thereafter, the user interface in the debugger adapts itself to the particular target being debugged and accommodates interfacing with a user by presenting information to the user corresponding to, for example, the particular register and memory configuration of the target being debugged.

### BACKGROUND OF THE INVENTION

1. Field of the Invention

The present invention is generally in the field of debuggers for processors and, more particularly, in the field of user interfaces for such debuggers.

2. Background Art

Software for embedded systems is conventionally developed using a single microcontroller or a digital signal processor (DSP) and either an emulation or simulation module to which a debugger is attached. A debugger is a tool that aids a programmer or developer in locating and correcting errors in the system. In the case of a simulation module, the system and the debugger are both implemented in software.

FIG. 1 illustrates a conventional exemplary single-processor system simulation, i.e. debugging system 100. In the present application, the entity upon which a debugger acts will be referred to as a “target” within a “system simulation.” A system simulation may include, for example, several targets, a scheduler, and a shared system resource such as a shared memory. Furthermore, a target may contain a central processing unit (CPU), among other elements. In FIG. 1, debugging system 100 includes a conventional debugger, i.e. debugger 110, which communicates with a processor model, i.e. system simulation 120.

Debugger 110 may be used to control and display the state of system simulation 120, through a variety of standard debugging functions. For example, debugger 110 may send “run”, “stop”, or “step” commands to the target. Furthermore, debugger 110 may “read” data from memory or registers within system simulation 120, or “write” data into memory or registers within system simulation 120. In addition to the aforementioned debugger functions, debugger 110 also requires an additional set of functions and components in order to customize the functionality for a specific target. In particular, a debugger must be designed to have interfaces that are compatible to the various types of registers and memory within a target.

Typically, debuggers are customized by the manufacturer according to their intended target, e.g. an Intel® processor or a Motorola® processor. When faced with a new type of target, a conventional debugger must undergo substantial software code modifications, i.e. the debugger must be “re-targeted”, before it can properly interface with the new target. Referring to the conventional debugging system 100 of FIG. 1, if system simulation 120 was altered or replaced with a different type of system simulation, the manufacturers of debugger 110 would have to build a custom version of debugger 110 that can operate with the new system simulation. Currently, with the rapid changes in processor technologies, manufacturers of debuggers are continually forced to rebuild different versions of their debuggers to suit different processors, a practice that is both time consuming and technically laborious.

Thus there is a need in the art for a debugger system that does not have to be rebuilt or customized in order to effectively and properly operate with different or new targets.

### SUMMARY OF THE INVENTION

The present invention is directed to method and system for an adaptable user interface in a debugger. The present invention resolves the need in the art for a debugger that does not have to be rebuilt in order to effectively and properly operate with different or new targets.

In one embodiment, the invention is a method for adapting a user interface of a debugger to a given target where the method includes querying the target for target-specific information. For example, the target is queried by a debug core in the debugger to obtain target-specific information such as register groups, a register map, information about compound registers, memory address spaces, and memory blocks in the particular target being debugged. In this embodiment, the debugger interfaces with the target through various register and memory “application program interfaces” (“APIs”).

After the target-specific information is obtained by the debug core in the debugger, such information is transmitted to the user interface in the debugger. Thereafter, the user interface in the debugger adapts itself to the particular target being debugged and accommodates interfacing with a user by presenting information to the user corresponding to, for example, the particular register and memory configuration of the target being debugged. In other embodiments, the present invention is a system capable of, or a computer readable medium having a computer program capable of, carrying out the invention's method.

In a manner described below, the present invention results in an adaptable user interface in a debugger. Other features and advantages of the present invention will become more readily apparent to those of ordinary skill in the art after reviewing the following detailed description and accompanying drawings.

### BRIEF DESCRIPTION OF THE DRAWINGS

FIG. 1 illustrates an exemplary conventional single processor simulation environment.

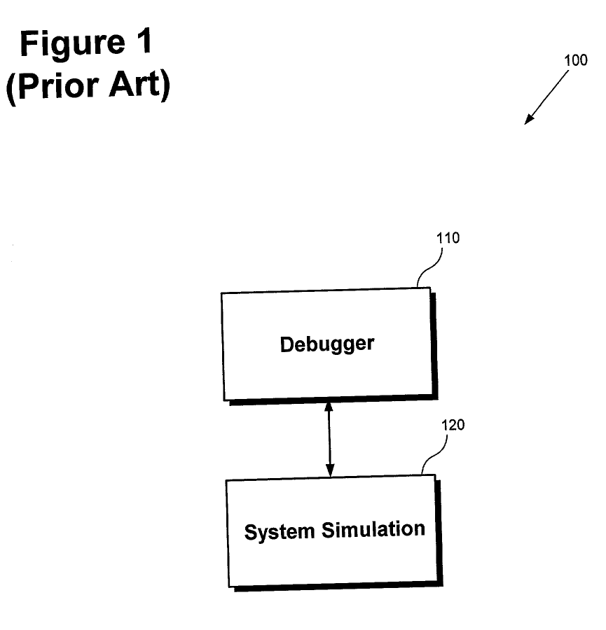

FIG. 2 illustrates an embodiment of an exemplary debugger within the invention's debugging system.

FIG. 3 illustrates exemplary display windows in the user interface of the invention's debugging system.

FIG. 4 is an exemplary process within the invention's debugging system.

### DETAILED DESCRIPTION OF THE INVENTION

The present invention is directed to method and system for an adaptable user interface in a debugger. The following description contains specific information pertaining to implementation of specific embodiments of the invention. However, one skilled in the art will recognize that the present invention may be implemented in a manner different from that specifically discussed in the present application. Moreover, some of the specific details, which are within the knowledge of a person of ordinary skill in the art, are not discussed to avoid obscuring the present invention.

The drawings in the present application and their accompanying detailed description are directed to merely exemplary embodiments of the invention. To maintain brevity, other embodiments of the invention which use the principles of the present invention are not specifically described in the present application and are not specifically illustrated by the present drawings.

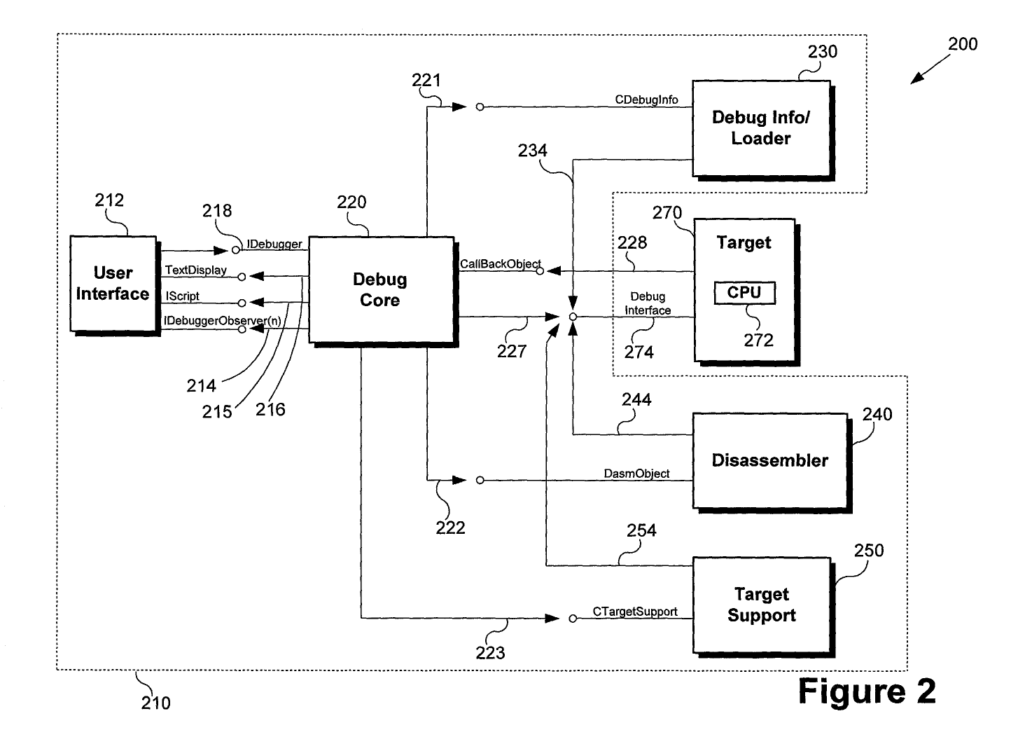

An exemplary embodiment of a debugging system is shown in FIG. 2, i.e. debugging system 200. Debugging system 200 comprises debugger 210 and target 270, where debugger 210 can be used to debug target 270. As shown in FIG. 2, debugger 210 comprises user interface 212, debug core 220, debug info/loader 230, disassembler 240, and target support 250. In the present exemplary embodiment, target 270 comprises a single processor, i.e. CPU 272. In one embodiment of the present invention, user interface 212 may be a graphic user interface.

In FIG. 2, user interface 212 may include access to multiple interfaces, e.g. “IDebuggerObserver” via communication line 214, “IScript” via communication line 215, and “TextDisplay” via communication line 216. Debug core 220 includes a dynamically loaded library (DLL) that might include access to two interfaces: “IDebugger” via communication line 218 and “CallBackObject” via communication line 228. “IDebugger” and “CallBackObject” may be C++ interfaces implemented as a single class using multiple inheritances. In the present embodiment, debug core 220 is a CPU-independent portion of debugger 210, such that it is not target-specific and may be used with any type of target or CPU. Instead, debug core 220 utilizes a set of additional support components, such as debug info/loader 230, disassembler 240, and target support 250, to customize the functionality for a specific target, i.e. target 270. It is noted that, in the present application, a “communication line” refers to any appropriate hardware and/or software interface between the relevant hardware and/or software modules.

As stated above, in the exemplary embodiment of FIG. 2, the additional support components within debugger 210 comprise debug info/loader 230, disassembler 240, and target support 250, each of which can be implemented as a DLL that includes access to programming interfaces based on the type of target(s) or CPU(s) in the system simulation. Debug info/loader 230, disassembler 240, and target support 250, may each include a single C++ interface, e.g. debug info/loader 230 includes interface “CDebugInfo” via communication line 221, disassembler 240 includes interface “DasmObject” via communication line 222, and target support 250 includes interface “CTargetSupport” via communication line 223. As an example, CPU 272 may be an “Advanced RISC-based Machine” (“ARM”) processor that utilizes debug info/loader 230 for file formatting, disassembler 240 for ARM instruction set information, and target support 250 for ARM ‘C’ compiler information.

Communication lines 221, 222, and 223 facilitate communication from debug core 220 to debug info/loader 230, disassembler 240, and target support 250, respectively. Communication lines 234, 244, and 254, facilitate communication from debug info/loader 230, disassembler 240, and target support 250, respectively, to target 270. Referring to debug core 220, communication line 227 facilitates communication with target 270, and communication line 228 facilitates communication from target 270 to debug core 220.

Communication line 227 provides access to a “debug interface” that is exposed by CPU 272 in target 270, i.e. debug interface 274. Moreover, each debuggable object in target 270, e.g. CPU 272, can expose a debug interface 274 that can be accessed by debugger 210. Debug core 220 exposes an “application program interface” (API) or a “debug API”, via communication line 228, that facilitates communication with target 270. In the present application, debug APIs which are found in conventional debuggers will be referred to as “standard debug APIs”. For example, debugger 210 can send “run”, “stop”, “step”, “read”, or “write” commands to target 270 via communication line 227 using standard debug APIs. More specifically, debugger 210 may “read” data from memory or registers within target 270 using a “read API”, or “write” data into memory or registers within target 270 using a “write API”. In general, debugger 210 may utilize an API by issuing a “call” to the particular debug API, which is communicated to debug interface 274 of CPU 272, via communication line 227.

In the present invention, debugger 210, through communication line 227, queries target 270 for detailed target-specific information regarding its register and memory maps. Debugger 210 can access, via communication line 227 and debug interface 274, a register map which includes a list of all the registers that exist in CPU 272 of target 270, the size of each register, and the relationship between registers. Debugger 210 can also access, via communication line 227 and debug interface 274, detailed information about the types of memory that exist in CPU 272 of target 270, such as the number and type of memory spaces. Based on the information obtained from its query of target 270, debug core 220 helps user interface 212 adapt to the particular target 270 through, among other things, use of IDebugger API 218. The present invention provides the aforementioned capabilities by implementing a number of non-standard debug APIs, i.e. “register APIs” and “memory APIs”, which are not present in conventional debuggers.

Memory APIs are used by debug core 220, via communication line 227 and debug interface 274, to access the memory within target 270. An exemplary embodiment of the present invention includes two memory APIs, i.e. “MemGetSpaces” and “MemGetBlocks”. The first API, MemGetSpaces, would typically be called by debugger 210 after connecting to the target but before accessing memory. The MemGetSpaces API provides debugger 210 with the number of independent address spaces available on target 270. Different memory spaces should be used to separate distinct memory areas, e.g. “PRAM” (“Program RAM”) and “DRAM” (“Data RAM”). The second API, MemGetBlocks, is used by debugger 210 for each memory space specified by the MemGetSpaces API, before accessing memory in that space. This returns the layout of the memory in a single address space, i.e. retrieves the list of memory blocks within a particular memory space. This call returns existing memory blocks only, such that the caller can assume that any memory not in a block is a hole or invalid memory, for example. In addition to the two memory APIs described above, debug core 220 may also have a variety of other standard debug APIs, e.g. a “MemWrite” API for writing new values to the memory of target 270, or a “MemRead” API for reading memory from target 270.

Register APIs are used by debug core 220, via communication line 227 and debug interface 274, to access the registers within target 270. An exemplary embodiment of the present invention includes three register APIs, i.e. “RegGetGroups”, “RegGetMap”, and “RegGetCompound”. The first register API, RegGetGroups, is called upon by debugger 210 to retrieve register groups from target 270. The second register API, RegGetMap, is typically called by debugger 210 after connecting to target 270. All registers are typically reported even if they are only a “sub-register” in a compound register, for example. Furthermore, register numbers are typically unique, even with respect to registers in other groups. The third register API, RegGetCompound, is called by debugger 210 to get information about a compound register, as reported by the RegGetMap API. A compound register, e.g. a flag register, is a register that is made up of sub-registers. In addition to the three register APIs described above, debug core 220 may also have a variety of other standard debug APIs, e.g. “RegWrite” for writing to a register in target 270, or “RegRead” for reading from a register in target 270.

Thus, using the two memory APIs and three register APIs described above, in addition to standard debug APIs, debug core 220 is able to adapt user interface 212 to the current target, e.g. target 270. In this manner, user interface 212 in debugger 210 is self-adapting to different targets based on information obtained from the query of target 270 by debug core 220. That is, based on information received from target 270, via communication line 228, user interface 212 is able to adapt to target 270, without modifications to the software code within debugger 210.

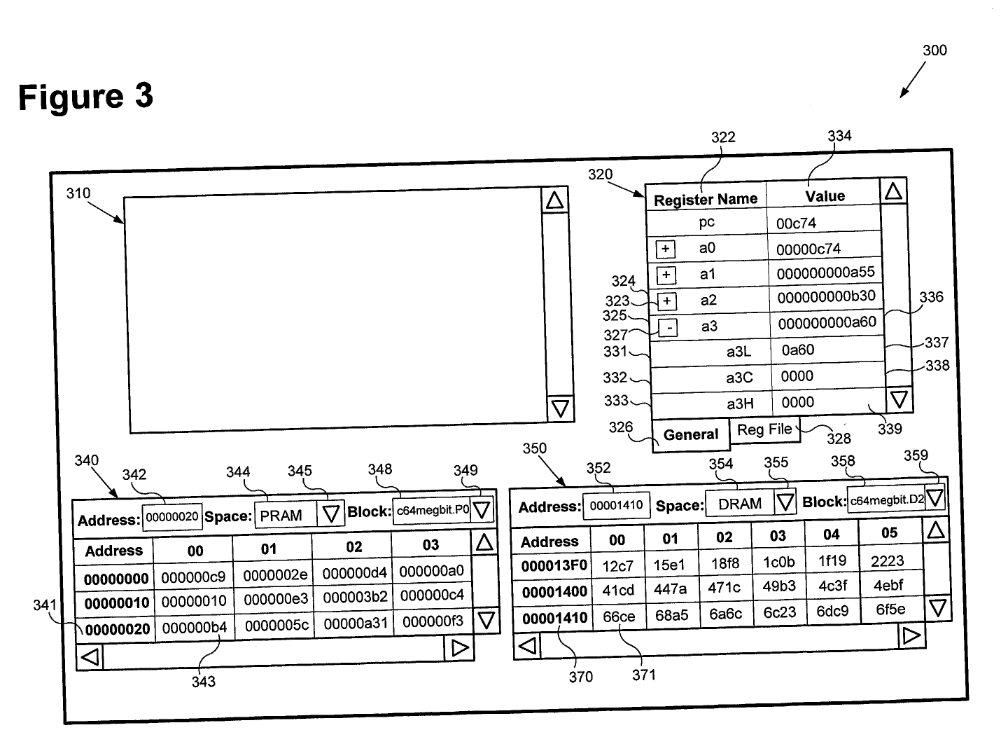

Referring to FIG. 3, debugger display 300 is an exemplary display screen of user interface 212 of the present invention. Debugger display 300 comprises command window 310, register window 320, memory window 340, and memory window 350. For the purpose of clarity, the following description of FIG. 3 is made with reference to the elements of debugging system 200 in FIG. 2.

Command window 310 displays the results of the execution of debugger commands. Once the debugger is started, command window 310 is displayed, allowing the user to write debugger scripts. In one embodiment, command window 310 is a TCL (“Tool Command Language”) shell with built-in debugger commands added to the language, and allows the user to write procedures or launch various programs. When a command is issued by the user, e.g. via a keyboard, command window 310 echoes the command and also gives the result of the execution.

Register window 320 displays the contents of the registers and flags in a CPU, e.g. the registers and flags of CPU 272 of target 270. By using register window 320, the values of any registers or flags in CPU 272 can be observed during debugging by debugger 210. The contents of register window 320 can be modified by clicking on register name 322, which displays the list of registers, e.g. register a2 in field 324 and register a3 in field 325. The list of registers shown below register name 322 are provided by the RegGetMap API, as described previously. When the register values are changed, they may be shown in a different color, e.g. red, to indicate that a change has been made. The number of registers listed under register name 322 may differ among different targets.

In the present embodiment, a “+” button adjacent to a register name, e.g. “+” button 323 in field 324, indicates a compound register that contains one or more sub-registers. Clicking on the “+” button displays the sub-registers below the compound register display, and consequently changes the “+” button into a “−” button, e.g. “−” button 327 in field 325. For example, register a3 in field 325 is a compound register which contains three sub-registers, i.e. sub-register a3L in field 331, a3C in field 332, and a3H in field 333. The sub-registers of compound register a3 are provided by the RegGetCompound API, as described previously. Clicking on “−” button 327 then hides the sub-registers and returns the “+” button, showing only the parent compound register again.

Adjacent to each register is a corresponding numerical value listed under value 334 that displays the register content (also referred to as the “register value”). In the present embodiment, the register values shown under value 334 are hexadecimal numbers, and each digit corresponds to 4 bits. For example, the 12-digit value corresponding to register a3 in field 325, i.e. value 336, is a 48-bit value. The three sub-registers of register a3 each contain a four digit register value, pointed to by numerals 337, 338, and 339, that is a four digit segment of value 336. For example, value 337 (i.e. 0a60) of sub-register a3L is equivalent to the “Lowest” four significant digits of value 336 while value 338 (i.e. 0000) of sub-register a3C is equivalent to the “Center” four significant digits of value 336 (i.e. 0000), and value 339 (i.e. 0000) of sub-register a3H is equivalent to the “Highest” four significant digits of value 336 (i.e. 0000). Also, register window 320 contains one or more default tabs depending on the target, e.g. “General” tab 326 and “Reg. File” tab 328. The default tabs available in register window 320 are provided by the RegGetGroups API, as described previously. General tab 326 and Reg. File tab 328 each represent a group of registers as defined by the target, e.g. target 270.

Memory windows 340 and 350 each contain a list of the program and data locations and their respective values. Referring to memory window 340, memory location 00000020 in field 341 has a corresponding value of 000000b4 in field 343. Similarly, in memory window 350, memory location 00001410 in field 370 has a corresponding value of 66ce in field 371. Memory windows 340 and 350 each contain an address field, a space field, and a block field. That is, memory window 340 contains address field 342, space field 344, and block field 348. Similarly, memory window 350 contains address field 352, space field 354, and block field 358. If a target has more than one memory space, then the user can select which memory space to display. For example, a user can select the memory space in space field 344 of memory window 340 by using scroll bar 345 to scroll through different memory spaces and make a selection, or similarly, by using scroll bar 355 of memory window 350 to select the memory space in space field 354. The various memory spaces available for selection in space field 344 and space field 354 are provided by the MemGetSpaces API, as described previously. A target may have code memory space, e.g. program random access memory (PRAM) as shown in space field 344 of memory window 340, data memory space, e.g. data random access memory (DRAM) as shown in space field 354 of memory window 350, or a CACHE memory space, for example. The types of memory spaces, e.g. DRAM, PRAM, or CACHE, that are displayed in memory windows 340 and 350 are determined by target 270 while user interface 212 is adapted to display the contents of various types of memory spaces that might exist in a particular target 270. Thus, referring to debugging system 200 of FIG. 2, the types of memory spaces displayed on user interface 212 are determined by the particular target 270 being debugged, and are not pre-programmed into user interface 212 of debugger 210.

Furthermore, memory windows 340 and 350 each contain a block field, i.e. block field 348 and block field 358, respectively. Block field 348 shows the memory block within the PRAM space that is currently being displayed, i.e. memory block c64megbit.PO. Similarly, block field 358 shows the memory block within DRAM that is currently being displayed, i.e. c64megbit.D2. The various memory blocks available for selection in block field 348 and block field 358 are provided by the MemGetBlocks API, as described previously. Moreover, the size of various memory blocks shown in block field 348 and 358 may differ between targets, e.g. a target may contain 1 Mb memory blocks, 2 Mb memory blocks, or 20 Mb memory blocks. The memory block in block field 348 can be changed by using scroll bar 349 to select from other available memory blocks within the current memory space. Similarly, the memory block in block field 358 can be changed by using scroll bar 359 to select from other available memory blocks within the current memory space.

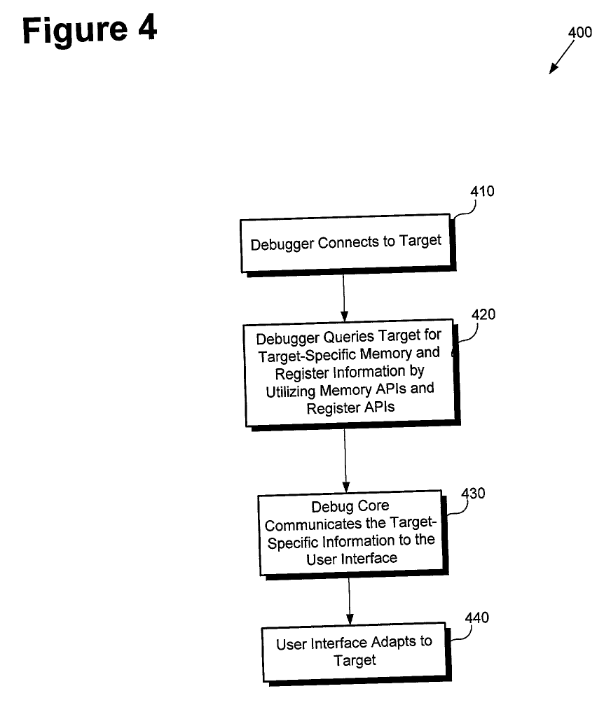

Referring to FIG. 4, process 400 illustrates an exemplary process within the present invention. For the purpose of clarity, the following description of process 400 includes references to debugging system 200 of FIG. 2. At step 410 of process 400, debugger 210 connects to target 270 via communication line 227 and debug interface 274. Continuing with step 420, debugger 210 queries target 270, via communication line 227, for target-specific memory and register information. In step 420, debugger 210 utilizes memory APIs and register APIs to retrieve the aforementioned target-specific memory and register information, as previously discussed in the description of debugging system 200 of FIG. 2. At step 430, debug core 220 communicates the target-specific memory and register information to user interface 212 via communication line 218. Finally, at step 240, user interface 212 is adapted to target 270 by utilizing the target-specific information provided by debug core 220.

In the present invention, the communication capabilities between debugger and target, e.g. the capabilities of communication line 227 of FIG. 2, have been expanded to allow debug core 220 to retrieve detailed target-specific information regarding the registers and memory within target 270. In one embodiment of the present invention, the aforementioned capabilities are facilitated by the implementation of a number of memory and register APIs not found in conventional debugging systems. This enhanced capability, in turn, provides user interface 212 with the information required to adapt to target 270. When a new target is introduced, process 400 is carried out and user interface 212 is able to self-adapt, or “re-target” itself, to the new target. This adaptive ability of the user interface allows the same debugger, e.g. debugger 210, to be used with a variety of targets with relative ease. This is in contrast to the considerable time and technical labor that is required to re-target conventional debuggers.

Thus, the invention provides method and system for self-adapting user interface in debugging systems. Those of skill in the art would understand that information and signals may be represented using any of a variety of different technologies and techniques. For example, data, instructions, commands and information that may be referenced throughout the above description may be represented by voltages, currents, electromagnetic waves, magnetic fields or particles, optical fields or particles, or any combination thereof.

Those of skill would further appreciate that the various illustrative system blocks, logical blocks, modules, and algorithm or method steps described in connection with the embodiments disclosed herein may be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative system blocks, logical blocks, and modules described in connection with the embodiments disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. The software module, also called a computer program in the present application, may contain a number of source code or object code segments and may reside in any computer readable medium such as a RAM memory, flash memory, ROM memory, EPROM memory, EEPROM memory, registers, hard disk, a removable disk, a CD-ROM, a DVD-ROM or any other form of computer readable medium known in the art. An exemplary computer readable medium is coupled to a processor, where the processor can read information from, and write information to, the computer readable medium. In the alternative, the computer readable medium may be integral to the processor. The processor and the computer readable medium may reside in an ASIC. In the alternative, the processor and the computer readable medium may reside as discrete components.

From the above description of the invention it is manifest that various techniques can be used for implementing the concepts of the present invention without departing from its scope. Moreover, while the invention has been described with specific reference to certain embodiments, a person of ordinary skill in the art would recognize that changes could be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

Thus, method and system for an adaptable user interface in a debugger have been described.

1. A method of adapting a user interface of a debugger to a target, said method comprising steps of:
querying said target for target-specific information by said debugger;
transmitting said target-specific information to said user interface of said debugger;
adapting said user interface of said debugger to interface with a user based on said target-specific information.

2. The method of claim 1 wherein said target-specific information comprises register groups in said target.

3. The method of claim 2 wherein said querying step comprises a step of querying said target to obtain said register groups from said target.

4. The method of claim 3 wherein said step of querying said target to obtain said register groups is performed by a first register API of said debugger.

5. The method of claim 1 further comprising a step of receiving said target-specific information by a debug core in said debugger after said transmitting step and before said adapting step.

6. The method of claim 5 wherein said debug core provides said target-specific information to said user interface before said adapting step.

7. The method of claim 1 wherein said target-specific information comprises a register map in said target.

8. The method of claim 7 wherein said querying step comprises a step of querying said target to obtain said register map from said target.

9. The method of claim 8 wherein said step of querying said target to obtain said register map is performed by a second register API of said debugger.

10. The method of claim 1 wherein said target-specific information comprises information about compound registers in said target.

11. The method of claim 10 wherein said querying step comprises a step of querying said target to obtain said information about said compound registers from said target.

12. The method of claim 11 wherein said step of querying said target to obtain said information about said compound registers is performed by a third register API of said debugger.

13. The method of claim 1 wherein said target-specific information comprises memory address spaces in said target.

14. The method of claim 13 wherein said querying step comprises a step of querying said target to obtain said memory address spaces from said target.

15. The method of claim 14 wherein said step of querying said target to obtain said memory address spaces is performed by a first memory API of said debugger.

16. The method of claim 1 wherein said target-specific information comprises memory blocks in said target.

17. The method of claim 16 wherein said querying step comprises a step of querying said target to obtain said memory blocks from said target.

18. The method of claim 17 wherein said step of querying said target to obtain said memory blocks is performed by a second memory API of said debugger.

19. A debugger comprising:
a debug core in communication with a target and a user interface;
said debug core including a plurality of register APIs and a plurality of memory APIs;
said debug core being capable of receiving target-specific information from said target through said plurality of register APIs and said plurality of memory APIs;
said user interface being capable of adapting to said target-specific information when interfacing with a user.

20. The debugger of claim 19 wherein said target-specific information comprises register groups in said target.

21. The debugger of claim 19 wherein said target-specific information comprises a register map in said target.

22. The debugger of claim 19 wherein said target-specific information comprises information about compound registers in said target.

23. The debugger of claim 19 wherein said target-specific information comprises memory address spaces in said target.

24. The debugger of claim 19 wherein said target-specific information comprises memory blocks in said target.

25. A computer readable medium embodying a computer program for debugging a target, said computer program comprising:
a first code segment for querying said target for target-specific information by said debugger;
a second code segment for transmitting said target-specific information to a user interface of said debugger;
a third code segment for adapting said user interface of said debugger to interface with a user based on said target-specific information.

26. The computer readable medium of claim 25 wherein said first code segment includes a code segment for obtaining register groups from said target.

27. The computer readable medium of claim 25 wherein said first code segment includes a code segment for obtaining a register map from said target.

28. The computer readable medium of claim 25 wherein said first code segment includes a code segment for obtaining information about compound registers from said target.

29. The computer readable medium of claim 25 wherein said first code segment includes a code segment for obtaining memory address spaces from said target.

30. The computer readable medium of claim 25 wherein said first code segment includes a code segment for obtaining memory blocks from said target.

31. The computer readable medium of claim 25 wherein said computer readable medium is selected from the group consisting of a CD-ROM and a DVD-ROM.
